(19) United States
(12) Patent Application Publication
(10) Pub. No.: US 2022/0179925 A1
(43) Pub. Date: Jun. 9, 2022

(54) SYSTEM AND METHOD FOR STORING, DELIVERING AND SCREENING VISUAL MEDIA

(71) Applicant: ARTinii lntl.a.s., Praha (CZ)

(72) Inventors: Vit Krajicek, Nucice (CZ); Ctirad Hemelik, Praha (CZ)

(73) Assignee: ARTinii lntl.a.s., Praha (CZ)

(21) Appl. No.: 17/114,072

(22) Filed: Dec. 7, 2020

(51) Int. Cl. G06F 21/10; H04L 29/06; G06F 3/048; H04L 29/08; H04L 9/06

(52) U.S. Cl. CPC G06F 21/10; H04L 65/60; H04L 2209/38; H04L 67/28; H04L 9/0643; G06F 3/048

(57) ABSTRACT

In a computer system connected to Internet and operative for storing, delivering and screening a visual media one or more database services are provided, one or more graphical user interfaces are served, one or more application programming interfaces are provided, and the graphical user interfaces are formed so that identification of an uploaded content and a proxy storage are made possible by serving the graphical user interface.

### BACKGROUND OF THE INVENTION

The present invention relates to a computer system for storing, delivering and screening of a visual media, in particular for public screening of visual media such movies, videos and another audiovisual content, as opposed to video on demand and/or video hosting,

There are two major stakeholders taken into account in the invention: right holders identified as RHs and customers who serve small audiences—small cinemas, festivals and casual screeners identified as SCFCs, leaving out major cinema operators as they are not affected by the problems solved by the present invention and have its own different relation to RHs.

RHs traditionally demand control over their assets even at the expense of not distributing those assets at all, so they have very reserved relationships with SCFCs since SCFCs usually have no access to the Digital Cinema Package (DCP) technology.

Even though SCFCs are marginalized, they are not at all a small segment, yet there are bottleneck present for serving them effectively. Their nature is of enthusiasm, less technical and with less ability to overcome excessive legal obstacles.

There are questionable solutions to media distribution for public screening, which are widely used but are not sufficient as they are violating intellectual property rights and/or are inaccessible to SCFCs.

As an option number one heretofore for distributing content for SCFCs is distribution of plain media files, e.g. mp4. Such files need to be stored on an accessible server, downloaded from it by a trusted SCFCs operator, and stored on SCFCs device which makes them an ideal target for IP infringement, leaking to the public. Such a system is illegal and vulnerable, depending on trust of all stakeholders.

As a common option number two is not distributing the media at all, monetizing the license, and leaving the burden of obtaining the media itself on the licensee. This usually leads to use of media which are not intended for public screening since even though they bought the license properly, they are actually about to use the media illegally, sometimes also displaying various visible watermarks and disclaimers about public screening being prohibited to an audience, which is unacceptable yet it is happening.

There is a professional industry standard in the place, Digital Cinema Package (DCP) which would solve the security issues but has two main drawbacks: the size of the media and the technical requirements for screening. While the files are often one or two hundreds of gigabytes in size it requires significant internet connection to download. Such a bandwidth is usually inaccessible to smaller entities and is a considerable blocking factor bypassed usually by physically sending a hard drive which is at least inflexible as it might take days or even weeks to obtain a screenable copy of the content. Such a lag introduces a real threat to scheduling the screening as the data can get lost or damaged on its journey through the physical space or through the network.

While the files are of such a size and the content being encoded in demanding codec, often being encrypted, the screening requires a professional encryption of a size of medium-sized bridge, a DCP projector which is inaccessible to SCFCs due its cost and lack of portability, software playback is not an option here because of computation& power demand consumer devices like PCs or laptops lack. Such a blocking factor usually forces these entities into option one, the consumer formats.

In order to solve this problem it has been known to use traditional methods of distribution separately. It has been unknown heretofore to provide an integrated system to cover the complete lifecycle of the movie flexible and secure enough, removing the necessity for trust of all stakeholders.

### SUMMARY OF THE INVENTION

Accordingly it is an object of the present invention to provide a new system and a new method for storing, delivering and screening a visual media which avoids the disadvantages of the prior art by lowering the barrier of entry for a secure end-to-end solution for digital media such as movie distribution for public screening which is significantly faster, easier to use and offers higher level of protection against piracy than other solutions.

In keeping with these objects and with others which will become apparent hereinafter one feature of the present invention resides, briefly stated, in a computer system connected to internet and operative for storing, delivering and screening a visual media, which has means providing one or more database services, means serving one or more graphical user interfaces, and means serving one or more application programming interfaces, wherein the graphical user interfaces are formed so that identification of an uploaded content and a proxy storage are made possible by serving the graphical user interface.

Another feature of the present invention resides in a method of storing, delivering and screening a visual media by a computer system connected to internet and operative for storing, delivering and screening a visual media, which is implemented by the above-specified computer system connected to Internet and operative for storing, delivering and screening a visual media.

In accordance with the present invention there is thus provided an on-line movie distribution platform that lowers the barrier of entry for a secure end-to-end solution for digital movie and other visual media distribution for public screening, that is significantly faster, easier to use and offers higher level of protection against piracy than previously existing solutions, since it forms an integrated system to provide graphic user interfaces for RH to register, identify the movie content, submit it and manage it, for SCFCS to register identify themselves, identify the audience and acquire rights for screening.

The new system and method provide a state of the art movie or video player which ensures seamless content delivery, playback, protection and reporting for rights holders. The user interfaces are backed by a system of services and storages securing the content and data while offloading technological and legal complexity for all stakeholders.

The present invention relates to RHs and their relation to SCFCS with the intention to organize public screening of a movie. The RHs have a need to pass their content to their customers according to the rights they are holding for a specific territory, time period and properties of the screening place in such a way that their content cannot be misused and violate the rights to the content. Customers satisfy a need to easily acquire rights to public screening without excessive legal overhead and perform the public screening safely without a danger of having the content leaked accidentally or intentionally.

With the present invention the problems associated with legal overhead, computer security, post-production challenges, content delivery security for ail stakeholders of the transaction: the RHs and SCFCs are solved by providing an integrated computer system consisting of a user interface for submitting all necessary legal documents and media content, a user interface that serves as a marketplace for ordering media content, accessible database services and offline services which those interfaces rely on, offline services, proxy storages bridging public services and offline services and storages, and an installable software player which automatically downloads ordered media content and after playback report the use of the license.

Moreover, personalized invisible watermarks to identify possible leak source, tracking it to a specific order item are embedded in the content. The information being encoded into said invisible watermarks are user identification, a screening place identification from which territory and location, time interval for the screening can be deduced.

### BRIEF DESCRIPTION OF THE DRAWINGS

FIG. 1 of the drawings is a simplified view of stakeholders interacting with a system according to the present invention; and

FIG. 2 of the drawings is a view showing a block diagram of the system according to the present invention and illustrating how the system works towards reducing the complexity visible from the point of view of a rightsholder and a customer.

### DESCRIPTION OF THE PREFERRED EMBODIMENTS

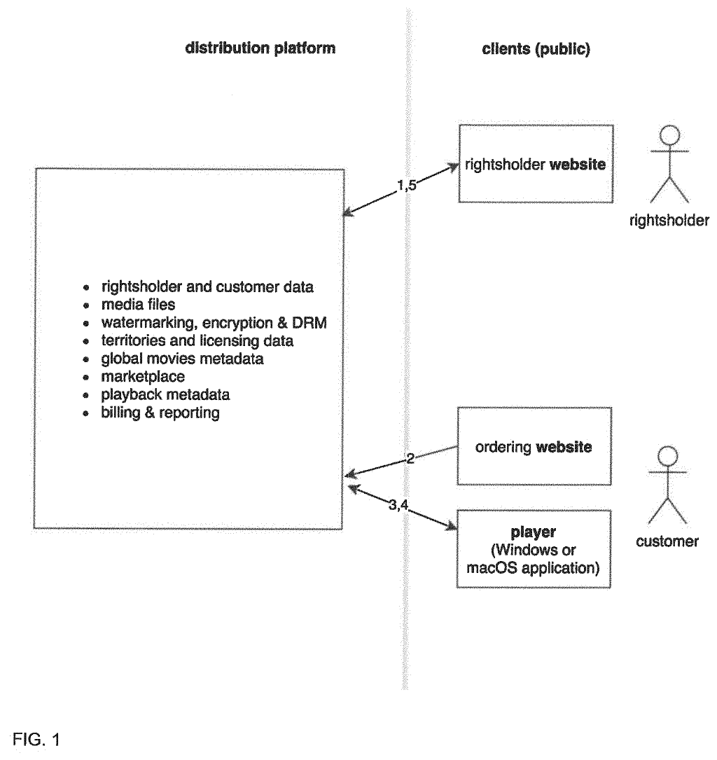

As can be seen from FIG. 1 in the computer system for storing, delivering and screening of a visual media a rightsholder 1—submits a movie to a catalog, i.e. creates a new record in the catalog. The rightsholder 2—gets signed an upload link, such that only the current rightsholder can put the blob into a proxy—temporarily with the link having set expiration, and no one excepted a non-public cluster can read the file.

The rightsholder 3—uses a signed upload link to upload a file to a proxy storage. Since no one can access the non-public cluster, the only way is through the proxy storage. 4—the non-public processing cluster downloads the submitted blob from the proxy storage, and preprocesses the movie. Since it constantly polling the catalog service, it knows about the new record and the location of the submitted blob.

A customer 5—places a new order (plus notarization of order in blockchain). 6—after personalization a processing cluster uploads the blob to the proxy storage. The personalization means that every order item guide gets its own unique and identifiable set of watermarks and an encryption/decryption key. 7—post process info (download a link and one part of the decryption key) to public services. 8—authenticated player asks for a signed down link. No one except the authenticated player can access the info about the location of the blob and the authentication details to download it. 9—a player downloads the blob. 10—the player asks for one part of the key to decrypt and play the AV content.

The player uses the requested part of the key together with the other part of the key to decrypt the movie-on-the fly, in the memory during the playback. There is no on-disc cache or buffer containing unencrypted content. 11—submit playback metadata (plus notarization of playback in blockchain), i.e. report license usage.

In the system according to the present invention, to mitigate the need for thrust between the stakeholders, the security architecture plays an important role. Strict secret management and service competence need to be laid out. There are at least three access zones: the public zone, the proxy zone, the nonpublic zone.

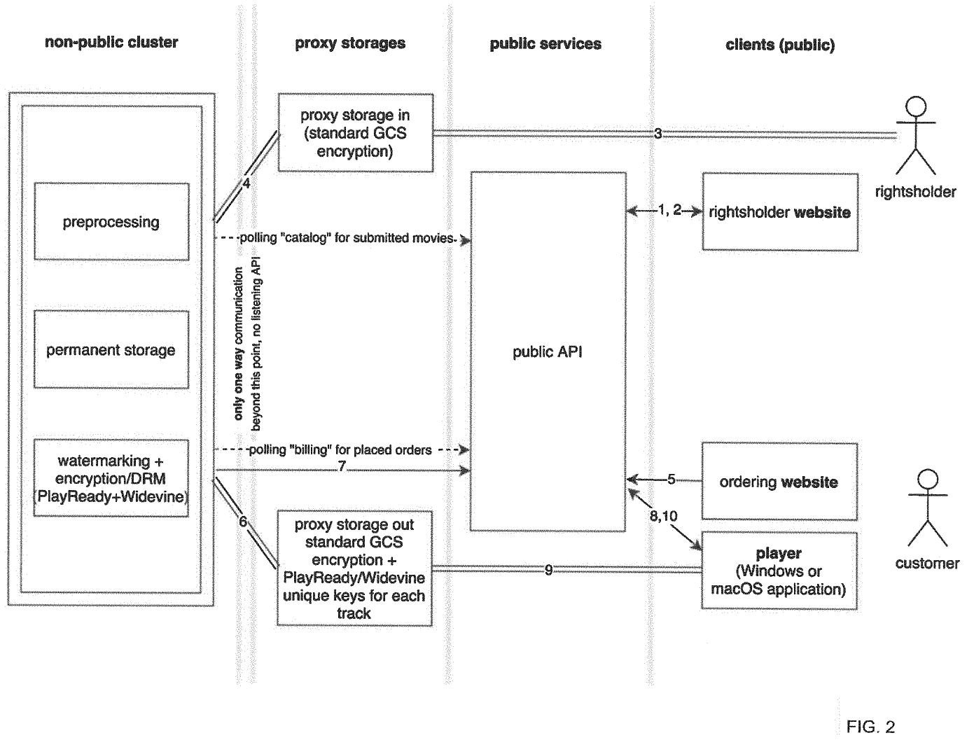

As can be seen from FIG. 2 the present invention is incorporated in a computer system, more precisely the computer system which is a system of services in server dusters. Each duster represents an access zone.

In the public zone there is the location of services (their http servers) which need to be accessible from the internet, they have IP addresses, domain names, etc. They are used by clients (frontend, desktop or mobile applications) through authenticated http requests, user and role based permission control. There is a strict role based access in communication of services in this part, especially in regard to secret management, e.g. no actor (service or human operator) except authentication service can access a private key used to sign Json Web Tokens (JWT) used for authentication and authorization between clients and services and between services themselves.

In the non-public zone there is a location of the services and storages which must not be accessible from the Internet for security reasons. Services here cannot accept any communication from outside. These do not have any public IP, nor the duster itself does not have a public P. Services and workers inside this zone do not have any http API to accept http requests—communicating via a message broker.

In the proxy zone there are storages as an intermediary between public and non-public zones so that the non-public part of the system can accept media files from outside, yet can be completely invisible from the Internet. Storing files in this zone has two main rules: files get deleted immediately after successful transfer from public to non-public, and vice versa. Only there is only one actor which can give a time constrained write only access to a variable and unique part on the proxy storage, i.e. create a signed url which accepts only http PUT method.

Moreover ail sides are checking the file content via cryptographic hashes—any inconsistency results in an exception and the process needs to be started over again. The above measures are mitigating an unauthorized access to RHs assets, allowing only controlled (encrypted and watermarked with DRM on top) content exit the cluster where storages are accessible from.

The present invention is not limited to the details shown since various modifications and structural changes are possible without departing from the spirit of the invention.

What is desired to be protected by Letters Patent is set forth in particular in the appended claims.

What is claimed is:

1. A computer system connected to internet and operative for storing, delivering and screening a visual media, comprising
means providing one or more database services;
means serving one or more graphical user interfaces; and
means serving one or more application programming interfaces, wherein the graphical user interfaces are formed so that identification of an uploaded content and a proxy storage are made possible by serving the graphical user interface.

2. A computer system according to claim 1, wherein the graphical user interfaces are formed so that specifying rights of right holders are offering including a time period and a territory by serving a graphical user interface.

3. A computer system according to claim 1, wherein the computer system has a part formed so that it is communicating only in one direction and so that no incoming connections to the computer system are possible so that the computer system is formed as an isolated system.

4. A computer system according to claim 3, the isolated system is formed so that an ingest, a storage, drm, and a proxy storage are carried out in the isolated system.

5. A computer system according to claim 1, wherein a desktop application or a mobile application is connected to the application programming interfaces and is polling for available downloads downloading an encrypted or an unencrypted content immediately or with a delay after receiving a download link with no user interaction needed.

6. A computer system according to claim 5, wherein the desktop application or the mobile application connected to the application programming interfaces is configured so that it is requesting a description key or a part of the description key for the downloaded encrypted content.

7. A computer system according to claim 5, wherein the desktop application or the mobile application connected to the application programming interfaces is configured so that after a partial and/or a complete playback it notarizes a use of a license in a blockchain transaction to make it immutable and inspectable by a public and a rights holder third party.

8. A computer system according to claim 1, further comprising a part which is inaccessible from the internet and in which an encryption key is generated and an encryption of a content by the encryption key is carried out.

9. A method of storing, delivering and screening a visual media by a computer system connected to internet, comprising the steps of
providing one or more database services;
serving one or more graphical user interfaces;
serving one or more application programming interfaces; and
forming the graphical user interfaces so that identification of an uploaded content and a proxy storage are made possible by serving the graphical user interface.

10. A method according to claim 9, wherein the forming of the graphical user interfaces is provided so that specifying rights of right holders are offering including a time period and a territory by serving a graphical user interface.

11. A method according to claim 9, further comprising forming in the computer system a part such that it is communicating only in one direction and so that no incoming connections to the computer system are possible so that the computer system is formed as an isolated system.

12. A method according to claim 11, further comprising forming the isolated system so that an ingest, a storage, drm, and a proxy storage are carried out in the isolated system.

13. A method according to claim 9, further comprising connecting a desktop application or a mobile application connected to the application programming interfaces and polling by the desktop application or the mobile application for available downloads downloading an encrypted or an unencrypted content immediately or with a delay after receiving a download link with no user interaction needed.

14. A method according, to claim 13, further comprising requesting by the desktop application or the mobile application connected to the application programming interfaces a description key or a part of the description key for the downloaded encrypted content.

15. A method according to claim 13, further comprising configuring the desktop application or the mobile application so that after a partial and/or a complete playback it—notarizes a use of a license in a blockchain transaction to make it immutable and inspectable by a public and a rights holder third party.

16. A method according to claim 9, further comprising providing a part which is inaccessible from the internet and in which an encryption key is generated and an encryption of a content by the encryption key is carried out.
